(19) United States
(12) Patent Application Publication
(10) Pub. No.: US 2019/0060164 A1
(43) Pub. Date: Feb. 28, 2019

(54) APPAREL WITH INFLATABLE LUMBAR SUPPORT DEVICE

(71) Applicant: PATTY VO, DALLAS, TX (US)

(72) Inventor: PATTY VO, DALLAS, TX (US)

(21) Appl. No.: 15/683,524

(22) Filed: Aug. 22, 2017

(51) Int. Cl. A61H 39/04; A41B 1/08

(52) U.S. Cl. CPC A61H 39/04; A61H 2205/081; A41B 1/08

(57) ABSTRACT

A system and method for providing lumbar support to a human spine is described. The system is compact, concealed, and carried within a garment of a user. The system includes a garment with an integrated pouch, an inflatable bladder, a pump, a valve, and a hose. The garment's pouch is located adjacent to the lower back of the user when the user is seated. The bladder is configured to support the lumbar of the spine while contained in the pouch. The hose allows passage of air between the pump and the bladder. The pump is contained inside a pocket in the garment. The valve regulates air pressure in the bladder. The bladder, pump, valve, and hose are detachable and removable from the garment.

### BACKGROUND

### 1. Field of the Invention

The present application relates to a lumbar support system, and more particularly to a removable inflatable support system that is designed to be inserted into a specially formed pocket built into the lumbar region of an outer garment worn over clothing, such as a coat, jacket, hoodie or vest.

### 2. Description of Related Art

A user that sits for extended period of time (e.g. a traveler, a desk job, confined to a wheelchair) may experience some discomfort and pain in the low back or lumbar region. Healthcare practitioners know that prolonged sitting can create pressure on the spine, distorting spinal curves and compressing discs. These can cause pinching of the nerves in the spinal cord which leads to numbness, tingling and serious back pain.

Standard chairs do not provide a curvature back rest. When the user sits down, the lumbar is forced up against the back of the seat, which is not a natural position. Postures outside of neutral, where the spine's curve is natural, are particularly troublesome as they lead to prolonged low-level muscle contractions and changes in intervertebral disc pressures. When sitting normally, the lumbar spine flattens and there is posterior migration of the nucleus. The pressure on the disc increases and there is increased passive strain on the posterior spinal elements. The seated lumbar pressures may be minimized by maintaining the natural back curvature.

Health care practitioners rely on a variety of methods to improve the seated postures of their patients, and lumbar support devices are commonly prescribed. A back support helps users with back pain by realigning the user's spine by inserting a back support in between the seat and the user's body. The lower spine is able to curve forward naturally and force the torso to straighten. This aligns the neck and spine, pushes the shoulders back, and takes unnecessary weight off the lower back and hips, relieving pain almost instantly for your upper and lower back.

There are various types of back support systems being proposed or introduced to remedy the problem. Current back support devices being proposed are typically for use in office chairs or vehicles. Most are strapped to the user or the user's chair which attempts to offer a solution to the problem, but each also has drawbacks.

U.S. Pat. No. 5,421,809 (Rise) pertains to a back support belt to be worn by the user. The invention includes a back support belt having a dual-belt assembly in which a wide, elastic inner belt completely encircles the abdominal and lower lumbar regions of the body. Which when inflated is bulky and visible to the public. A number of these devices have been designed to protect the lower lumbar region of the body for a particular type of activity. However, these types of support belts are either too flexible or too rigid to provide adequate support for a variety of user activities. For instance, a leather weight belt provides rigid support for the weight lifter, but is too inflexible to provide comfortable support during other more dynamic activities. All lack aesthetical appeal.

Furthermore, U.S. Pat. No. 5,205,814 (Podelitev) offers a lumbar region yielding support device adapted to be adjustably body positioned to be body worn or adjustably positioned attached to a seating structure. If strapped to the user, the lumbar support can be seen by others while the user is in public. Additionally, the lumbar support can wrinkle or detract from the user's chosen outfit. The visibility of the item and how it affects the user's clothing can decreases the users desire to wear the system.

Instead of wearing the system, users can place a lumbar support system on the user's seat back. These systems either rest against the seat or are attached to the seat by some type of strap. For example, in U.S. Pat. No. 4,471,993 (Watson) a semi-rigid support is provided with straps fasteners to secure the same to a seat back. In U.S. Pat. No. 4,597,386 to Goldstein a panel cushion combination is presented with attaching straps to secure the same to a seat back. In U.S. Pat. No. 4,789,202 to alter a vehicle cushion is shown embodying an inflatable element for application of back pressure.

For users who travel a lot, or use more than just one chair during the day, non-worn lumbar support systems are problematic. The system must be taken off one chair, transported to another chair, and put on the other chair. Users may experience discomfort with a medical system that is visible to other people (i.e. the public). Additionally, a user is more likely to forget to take a non-worn lumbar support system when changing locations. Forgetting the lumbar support system results in added costs (e.g. re-purchasing a lost support system or purchasing a second support system) and a time period when the user must sit in pain due to no lumbar support. Another problem lumbar supports have, especially non-worn support systems, is that they are bulky. Airlines are becoming more stringent on the limits of what a person can bring into the cabin of a plane. These devices can take up valuable space in the person's luggage, and users may not be able to wear them onto the plane due to concerns about air safety.

Although the foregoing references have provided abundant choices, there are still a lot of back care needs not being totally fulfilled or satisfied as yet. It is therefore an object of this invention to provide an aesthetically as well as a easy to carry lumbar support device or system that provides solutions for the above issues.

### DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1A is a front view of an inflatable lumbar support system according to an embodiment of the present application.

FIG. 1B is an exploded view of an inflatable lumbar support system of FIG. 1A.

FIG. 2 is an inside view of a garment designed to hold the inflatable lumbar support system of FIG. 1A.

FIG. 3 is a view of the inside of the garment of FIG. 2 with the inflatable lumbar support system of FIG. 1A.

FIG. 4 is a front view of the outside of the garment of FIG. 3 with a portion of the inflatable lumbar support system of FIG. 1A.

FIG. 5 is a side view of the inflatable lumbar support system of FIG. 1A located in relation to a user.

FIG. 6 is an alternate embodiment of the inside of the garment of FIG. 2.

FIG. 7 is a flow chart for the use of the inflatable lumbar support system of FIG. 1A.

While the device and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the device described herein may be oriented in any desired direction.

The system and method in accordance with the present application overcomes one or more of the above-discussed problems commonly associated with lumbar support devices and systems. The inflatable lumbar support system of the present application is compact enough to be incorporated into a garment the user can wear. Additionally, the garment can be incorporated into the user's wardrobe. Therefore, the system is discrete enough that a user can inflate and deflate it without being conspicuous. These and other unique features of the system are discussed below and illustrated in the accompanying drawings.

The system and method will be understood, both as to its structure and operation, from the accompanying drawings, taken in conjunction with the accompanying description. Several embodiments of the system may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

The inflatable lumbar support system of the present application is illustrated in the associated drawings. The system includes a bladder, a length of tube, a valve, and a pump. The pump is configured to pass air into the bladder, via the tube, such that the bladder inflates and expands its outer dimensions. The valve is configured to regulate the air in the bladder such that the bladder deflates and its outer dimensions decrease. The inflatable lumbar support system may also include a garment with an integrated pouch and channel. The pouch and channel are configured to contain the bladder and at least a portion of the tube. Additional features and functions of the system are illustrated and discussed below.

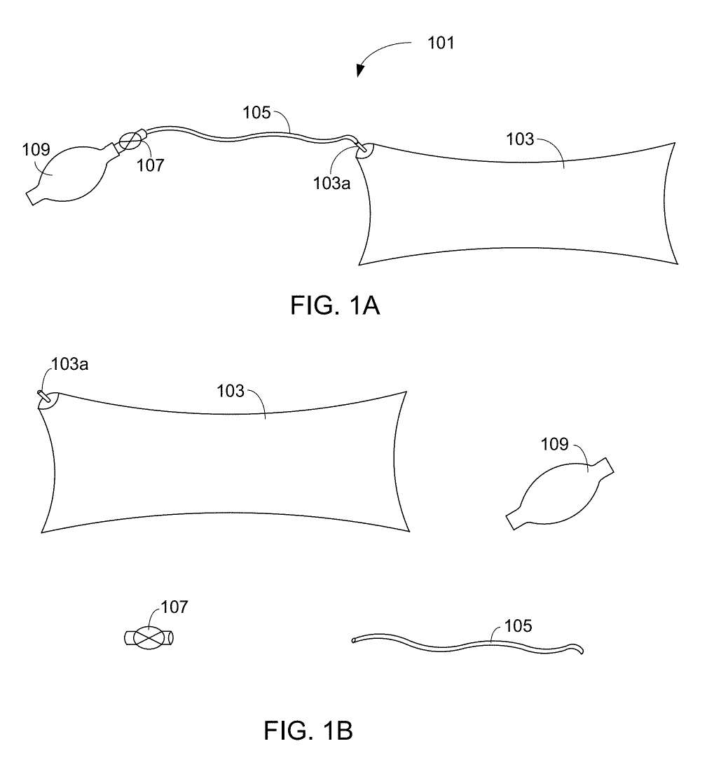

Referring now to the drawings wherein like reference characters identify corresponding or similar elements in form and function throughout the several views. FIGS. 1A and 1B illustrate a front view and an exploded view, respectively, of an inflatable lumbar support system 101. The system 101 is comprised of a bladder 103, a tube 105, a pump 109, and a valve 107.

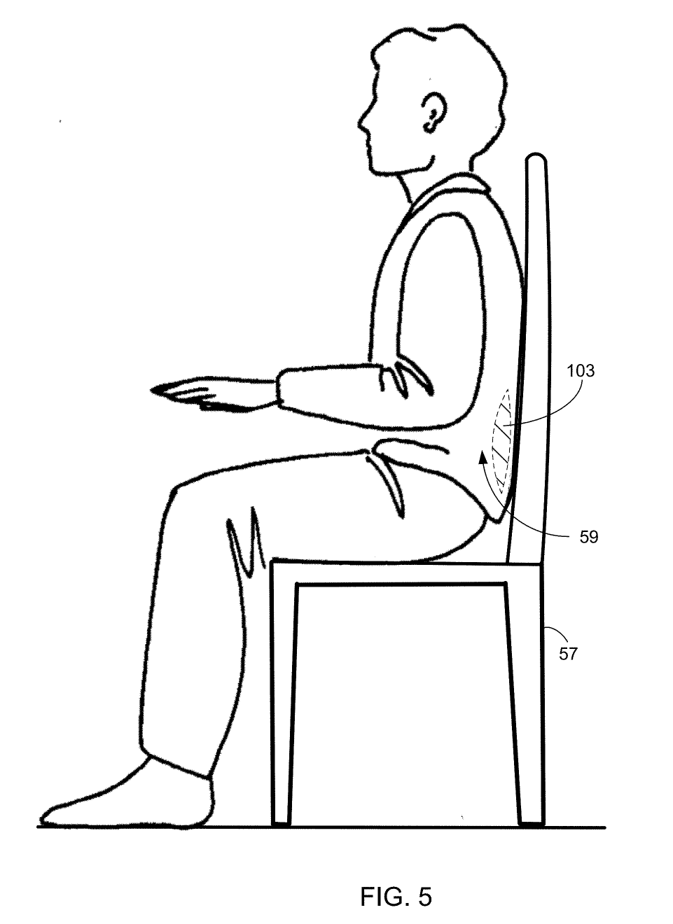

The bladder 103 provides the lumbar support for the user. The bladder 103 is configured to hold a specified volume of air, placed between a user's lumbar region 59 of the lower back and a chair 57 (seen in FIG. 5) or wall. Bladder 103 runs horizontally along the lumbar region 59. System 101 maintains the natural curvature of the user's lower spine. The bladder 103 may be manufactured to hold different volumes of air and may vary in its length and width. It is understood that the bladder 103 may be configured to hold any type of fluid and is not restricted to just air. The bladder 103 will have at least a port 103a in which the tube 105 can communicate with. While the port 103a is shown in one corner of the bladder 103, the port 103a may be located anywhere on the bladder 103. The port 103a is configured to provide an air tight connection to the tube 105 and may come in various designs.

The tube 105 is configured to connect to the bladder 103, at the port 103a, and to at least one of the valve 107 and the pump 109. The tube 105 is configured such that it is flexible along its length and have an internal diameter that allows for the pump 109, the valve 107, and the bladder 103 to be in fluid communication with each other.

The pump 109 is generally configured to at least increase the air pressure inside of the system 101 and inflate the bladder 103 such that the dimensions of the bladder 103 increase. As depicted, the pump 109 is bulbous in shape and operates through repeatedly manually squeezing of the bulb by the user. The pump 109 is not limited to just a manual pump and may use any other method to inflate the bladder 103 (e.g. an electric motor).

The valve 107 is generally configured to interrupt the fluid communication between the pump 109 and the bladder 103. Additionally, the valve 107 is configured to allow the user to release air pressure in the system 101 as desired. The valve 107 may also be configured to automatically release air pressure in the system 101 if the bladder 103 is inflated beyond its engineered safe pressure. The valve 107 is configured to be operated by touch; which would allow the user to release air pressure from the system 101 manually without looking at the valve 107. While the valve 107 is depicted in FIG. 1A as being in direct communication with the pump 109, it is understood that the valve 107 may be located at any portion of the system 101 (e.g. on the bladder 103).

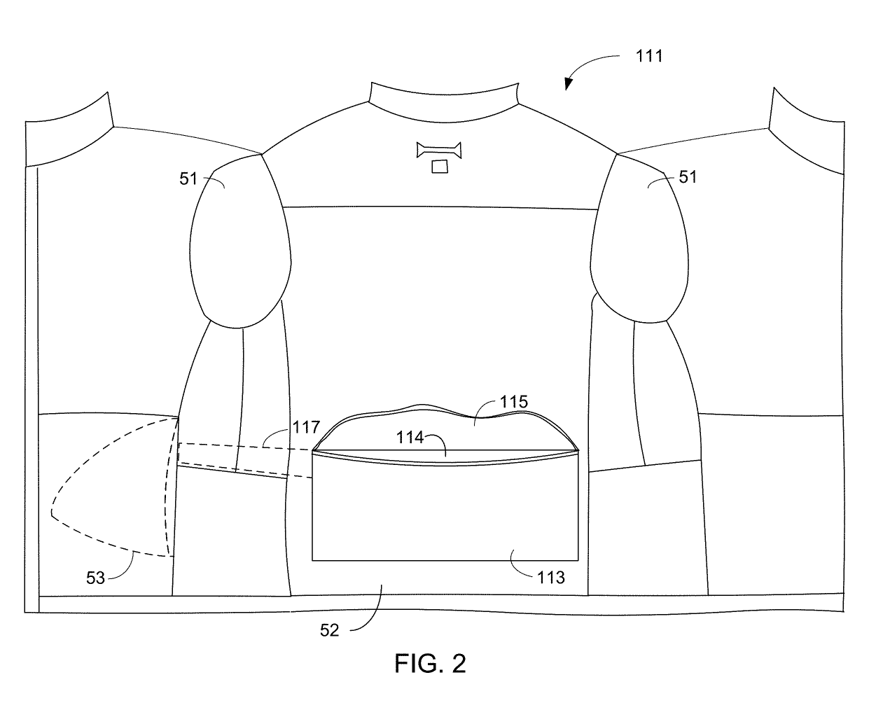

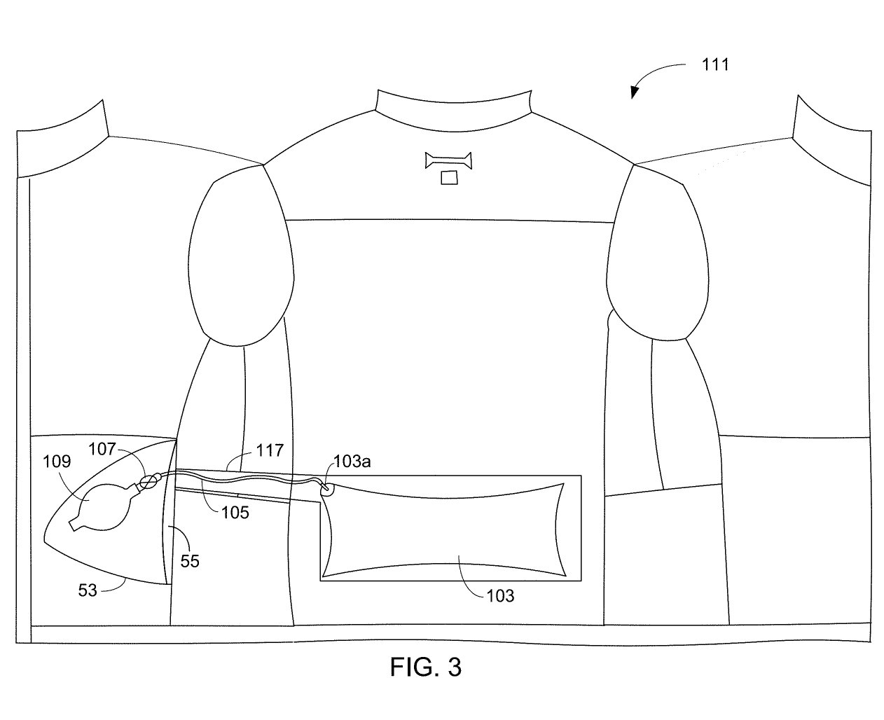

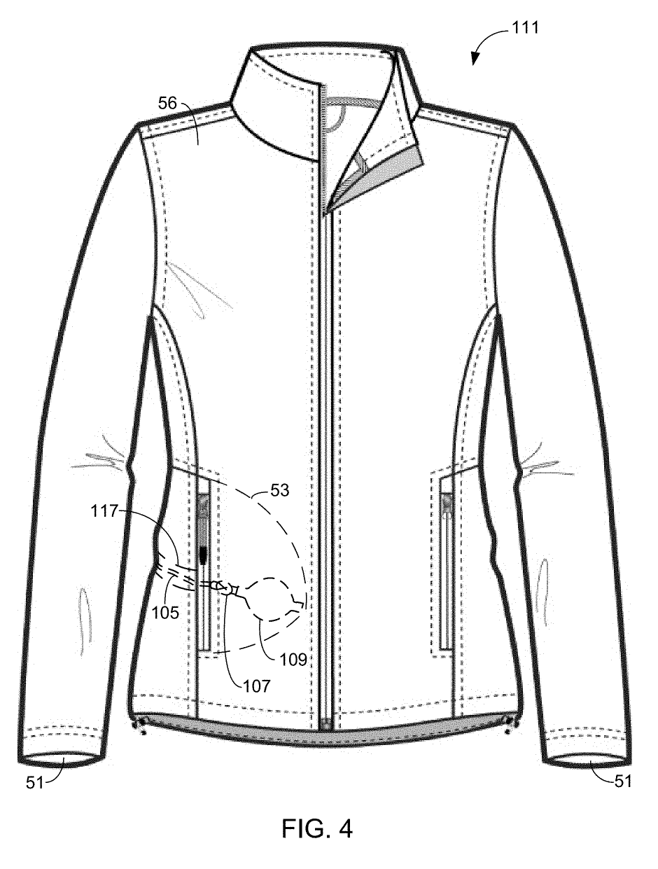

Referring now also to FIGS. 2-3 in the drawings, inside views of a garment 111, designed to hold the lumbar support system 101, are illustrated. The inflatable lumbar support system 101 may also include garment 111. The garment 111 is depicted as a coat laid completely flat, with the inside of two sleeves 51, a pocket 53, a pouch 113 and a channel 117 as shown. Pouch 113 is located between an outer layer 56 (seen in FIG. 4) and an inner layer 52 of garment 111. Incorporation of the pouch 113 and the channel 117 in between layers 52 and 56 of garment 111 allows system to be contained in clothing which are more fashionable. Additionally, system 101 is more discrete if it is hidden in the users clothing. Also, the user is more likely to be wearing the clothing or remember the clothing when changing locations. Though the garment 111 is depicted as a coat, it is understood that the pouch 113 and the channel 117 can be incorporated into another type of clothing including sweaters, shirts, dresses and so forth.

The pouch 113 is configured to contain the bladder 103. The pouch 113 is configured such that it rests adjacent to the lumbar region 59 (see FIG. 5) of the user's lower back when the user is seated. The pouch 113 has an interior opening 114 which is covered by a flap 115. The flap 115 is configured to cover interior opening 114 of the pouch 113 and secure the bladder 103 inside. The flap 115 may be secured to the pouch 113 by gravity or by some other method of selectively communicating one material to another. It is understood that system 101 can operated in garment 111 without using flap 115.

The channel 117 extends from the pouch 113 to the pocket 53. The channel 117 is configured to contain and hide a portion of the tube 105 between outer layer 56 (see FIG. 4) and inner layer 52. Alternatively, garment 111 could also be configured without channel 117. Tube 105 would still extend from pouch 113 and pocket 53 and would be located between the user and inner layer 52.

The pocket 53 has an exterior opening 55. The exterior opening 55 allows the user access to the pump 109 and the valve 107. The pocket 53 hides the pump 109, the valve 107, and a portion of the tube 105 from view of the public. In this embodiment, the pocket 53 used to contain the pump 109 and the valve 107 is a front pocket. Also, in the current embodiment, the pump 109 and the valve 107 are both contained in the pocket 53. It is understood that the garment 111 may be designed such that the pump 109 and the valve 107 may be contained in another type of pocket, including an interior breast pocket, and separated in different pockets.

Referring now also to FIG. 4, a front view of the outside of the garment 111 with a portion of the inflatable lumbar support system 101 is illustrated. FIG. 4 depicts one embodiment of the system 101 in the garment 111 when the pocket 53 is closed. As stated earlier, garment 111 can also be other types of clothing including sweaters, shirts, dresses and so forth. In this embodiment, the pump 109 and the valve 107 are in pocket 53. The valve 107 is in communication with tube 105 in the pocket 53. Tube 105 is enclosed in channel 117 and both continue around the back of garment 111 to pouch 113 and bladder 103 (not depicted). Garment 111 and system 101 can also be configured so that system 101 can be accessed through either right side (as depicted) or the left side of garment 111.

Referring now also to FIG. 5, a side view of lumbar support system 101 located in relation to a user is illustrated. Bladder 103 is shown in its approximate location on the user while the user is sitting in chair 57. As shown, bladder 103 provides support to the lumbar region 59 of the user's lower back. Bladder 103 is located inside garment 111, adjacent to the user's lumbar region 59 and chair 57.

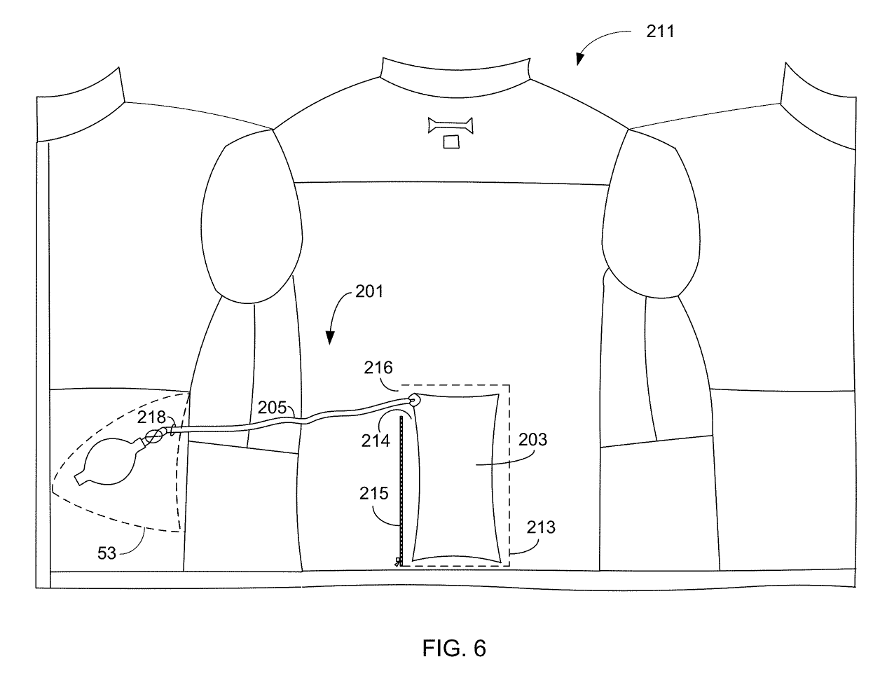

Referring now also to FIG. 6 in the drawings, an alternative embodiment of inflatable lumbar support system 101 is illustrated. inflatable lumbar support system 201 is depicted in FIG. 6. System 201 is similar in form and function to that of system 101 except as herein noted. Like reference characters identify corresponding or similar elements in form and function between system 101 and system 201. In this embodiment, bladder 203 runs vertically from the lumbar region 59. Bladder 203 is located in pouch 213. Pouch 213 has an interior opening 214. Bladder 203 is secured in interior opening 214 by a zipper 215. Zipper 215 extends along a portion of one side of pouch 213. While zipper 215 is illustrated to be on the side of pouch 213 which is closest to pocket 53, it is understood that zipper 215 can be located along any portion of pouch 213. Additionally, pouch 213 retains a side opening 216. Side opening 216 is configured so as to allow tube 205 to extend from interior opening 214 to pocket 53. In this configuration, tube 205 hangs free and is not secured to garment 211. Tube 205 accesses pocket 53 through a pocket opening 218. Pocket opening 218 is a slot like gap in which allows tube 205 to transition between the interior of garment 211 and the interior of pocket 53.

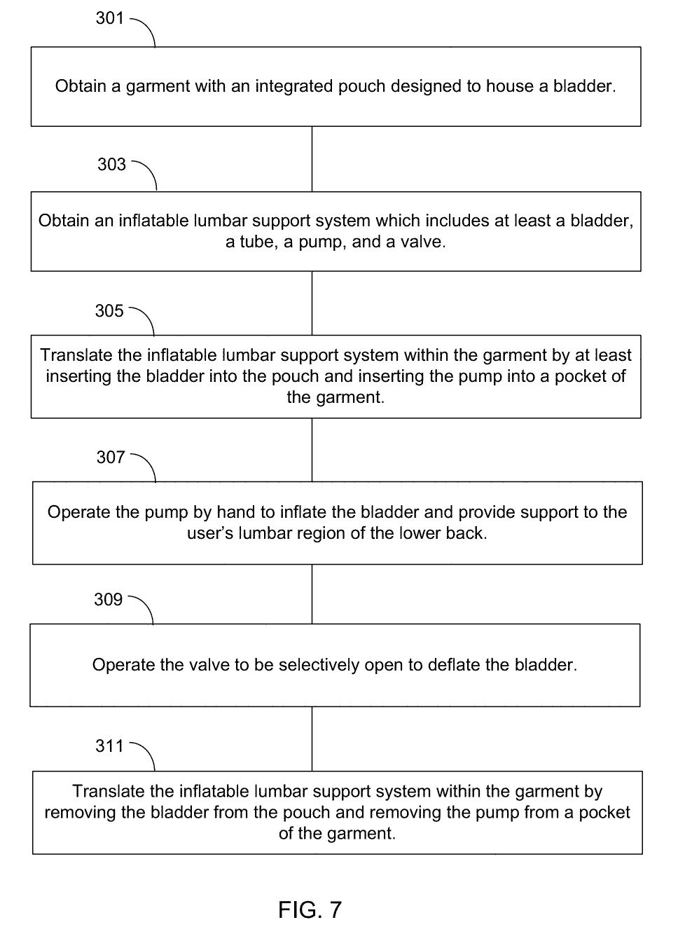

Referring now also to FIG. 7, a chart demonstrating the method for operation of the inflatable lumbar support system 101 is illustrated. The user obtains a garment with an integrated pouch designed to house a bladder, step 301. The pouch is located on the garment so that it rests at a height against the user's lumbar region of the back when seated. The user also obtains an inflatable lumbar support system which includes at least the bladder, a tube, a pump, and a valve, step 303. It is understood that either steps 301 and 303 may be performed first. Users may then translate the inflatable lumbar support system into the garment by at least inserting the bladder into the pouch and inserting the pump into a pocket of the garment, step 305. It is understood that the inflatable support system may be used without the garment. The user then operates the pump to inflate the bladder which provides support to the user's lumbar region of the lower back, step 307. While a hand pump is used here, it is understood that the bladder may be inflated in any manner, which could include the use of a motorized pump or compressed air in containers. The user is able to deflate the bladder by opening the valve, step 309. The user may translate the inflatable lumbar support system out of the garment by removing at least one of the bladder from the pouch and the pump from a pocket of the garment, step 311.

The current application has many advantages over the prior art including at least the following: (1) the system is compact enough to be incorporated into a garment; (2) the inflatable lumbar support system is discrete and may be operated without attracting attention of the public; and (3) the compact system allows for the garment to be designed in a more fashionable manner.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. An inflatable lumbar support system, comprising:
a garment with a pouch;
a bladder configured to slide into the pouch, the bladder configured to hold a volume of air;
a hose is in communication with the bladder and configured to permit the passage of air;
a pump in fluid communication with the bladder via the hose, wherein the pump is configured to increase fluid pressure in the bladder; and
a valve in fluid communication with the bladder, the valve is configured to release air pressure in the bladder;
wherein the pump and the valve together regulate air pressure in the bladder.

2. The system of claim 1, wherein the pouch is located on the garment so as to rest adjacent to a lumbar region of the user when the user is seated.

3. The system of claim 1, wherein the pouch has an opening along an inner layer of the garment.

4. The system of claim 1, wherein the bladder is inflatable.

5. The system of claim 1, wherein the bladder is configured to apply pressure to the user's lower back.

6. The system of claim 1, wherein the hose is detachable from at least one of the bladder, the pump, and the valve.

7. The system of claim 1, wherein the hose is located between an inner layer of the garment and an outer layer of the garment.

8. The system of claim 7, wherein the hose is located inside a channel in communication with the garment.

9. The system of claim 1, wherein the pump is operated by hand.

10. The system of claim 1, wherein the pump is located in a pocket of the garment.

11. The system of claim 10, wherein the pocket is a front pocket of the garment.

12. The system of claim 1, wherein the valve is configured to be selectively opened and closed to restrict air flow through the hose.

13. A method of using an inflatable lumbar support system, comprising:
obtaining a garment with an integrated pouch designed to house a bladder, wherein the pouch is located between an inner layer and outer layer of the garment so as to rest adjacent to a user's lumbar region of a lower back when seated;
obtaining an inflatable lumbar support system wherein the system comprises at least the bladder, a tube, a pump, and a valve;
translating the inflatable lumbar support system within the garment;
using the pump to increase air pressure in the bladder; and
using valve to decrease air pressure in the bladder.

14. The method of claim 13, further comprising:
inserting the bladder into the pouch.

15. The method of claim 13, further comprising:
inserting the pump into a pocket of the garment.

16. The method of claim 13, further comprising:
communicating the tube to at least one of the bladder, the valve, and the pump.

17. The method of claim 13, further comprising:
operating the pump by hand to increase the air pressure in the bladder, wherein the bladder inflates and supports the user's lumbar region of the lower back.

18. The method of claim 13, further comprising:
operating the valve to be selectively opened to reduce the pressure in the bladder.

19. The method of claim 12, further comprising:
detaching tube from at least one of the bladder, valve, and pump.

20. The method of claim 12, further comprising:
removing the bladder from the pouch.
